(19) United States
(12) Patent Application Publication
(10) Pub. No.: US 2008/0111424 A1
(43) Pub. Date: May 15, 2008

(54) Power storage device

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/599,616

(22) Filed: Nov. 15, 2006

(51) Int. Cl. G06F 1/26; H02J 7/00; H02J 3/00

(52) U.S. Cl. 307/65

(57) ABSTRACT

An improved structure of power storage device comprises at least three power sources and an uninterruptible power supply (UPS) system. The at least three power sources comprise a commercial power service and anyone selected from a fuel generator, a solar power generator, a wind power generator, a battery generator, and a fuel cell generator. The UPS system has a built-in power source selector. The UPS system has an output terminal for coupling with an electric appliance and an input terminal for connection with the at least three power sources via the power source selector. As a result, the UPS system becomes a power supply and the built-in power source selector selects another power source during the commercial power interruption so as to enable the electric appliance to work normally until the commercial power interruption is over.

### FIELD OF THE INVENTION

The present invention relates to an improved structure of power storage device, which is capable of selecting other electric power source, and more particularly to a power storage device, which is suitable for use in electric appliances, precision instruments, or the likes.

### BACKGROUND OF THE INVENTION

When a power failure occurs without any warning, it can cause damage to all trades and professions. It especially causes inestimable loss to specific trades and instruments. For example, when an unexpected power failure occurs, it can cause computer users to lose hours of work when their computers shut down without warning. In order to avoid the occurrence of this kind of accident, an uninterruptible power supply (UPS) has been disclosed to the public for supplying the auxiliary electric power for the computers. As a result, there is still plenty of time to backup data and shut down the computers so that the computers can be restarted after the restoration of electric power supply.

In fact, the aforesaid conventional UPS system outputs the electric power, which is stored therein during the supply of commercial power, so it only supplies the auxiliary electric power for the electric appliance for a short time. It cannot supply sufficient electric power to enable the long-term working of the computers. As a result, the computers cannot be restarted until the electric power supply is restored. In addition, the conventional UPS system is designed for only storing the commercial power so it is obviously not economical for the present energy-deficient society.

In view of the foregoing description, the motive of the present invention is to provide the general public with an improved power storage device, which is capable of selecting other electric power source.

### SUMMARY OF THE INVENTION

A major object of the present invention is to provide an improved structure of power storage device, which is capable of selecting other electric power source.

In order to achieve the above-mentioned object, an improved structure of power storage device is comprised of at least three power sources and an uninterruptible power supply (UPS) system. The at least three power sources comprise a commercial power service and anyone selected from a fuel generator, a solar power generator, a wind power generator, a battery generator, and a fuel cell generator. The UPS system has a built-in power source selector. The UPS system has an output terminal for coupling with an electric appliance and an input terminal for connection with the at least three power sources via the built-in power source selector. As a result, the UPS system becomes a power supply and the built-in power source selector selects another power source during the commercial power interruption so as to enable the electric appliance to work normally until the commercial power interruption is over.

The aforementioned object and other advantage of the present invention will be readily clarified in the description of the preferred embodiments and the enclosed drawings of the present invention.

### BRIEF DESCRIPTION OF THE DRAWINGS

FIG. 1 is a schematic block diagram showing the framework of the preferred embodiment of the present invention.

FIG. 2 is a block diagram showing the usage of the preferred embodiment of the present invention.

### DETAILED DESCRIPTION OF THE PREFERRED EMBODIMENT

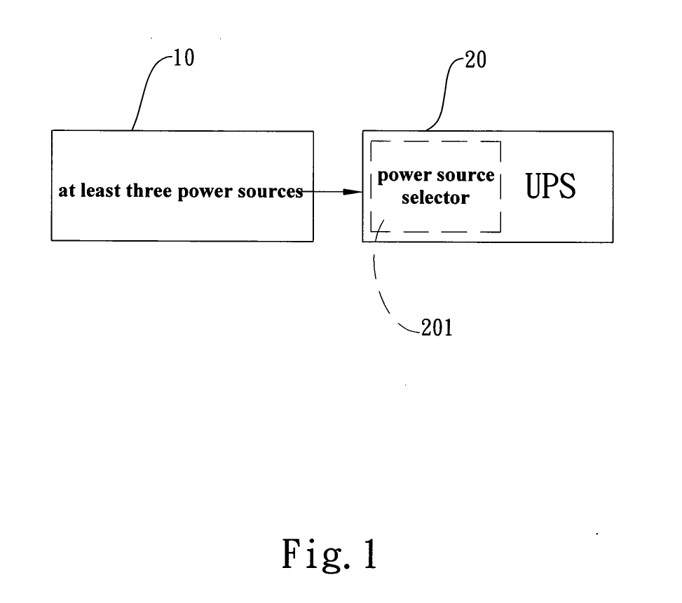

Referring to FIG. 1, a power storage device of the present invention generally comprises at least three power sources 10 and an uninterruptible power supply (UPS) system 20, wherein these power sources 10 comprise alternating current (AC) and direct current (DC) power sources such as a commercial power service and anyone selected from a manpower bicycle generator, a fuel generator, a battery generator, a wind power generator, a fuel cell generator, a solar power generator, and so on. The UPS system 20 has a built-in power source selector 201. The UPS system 20 is connected to these power sources 10 via the built-in power source selector 201. In addition, the UPS system 20 selects the power source by using a software program or by directly using a hardware device such as a relay, a reed switch, or a motor.

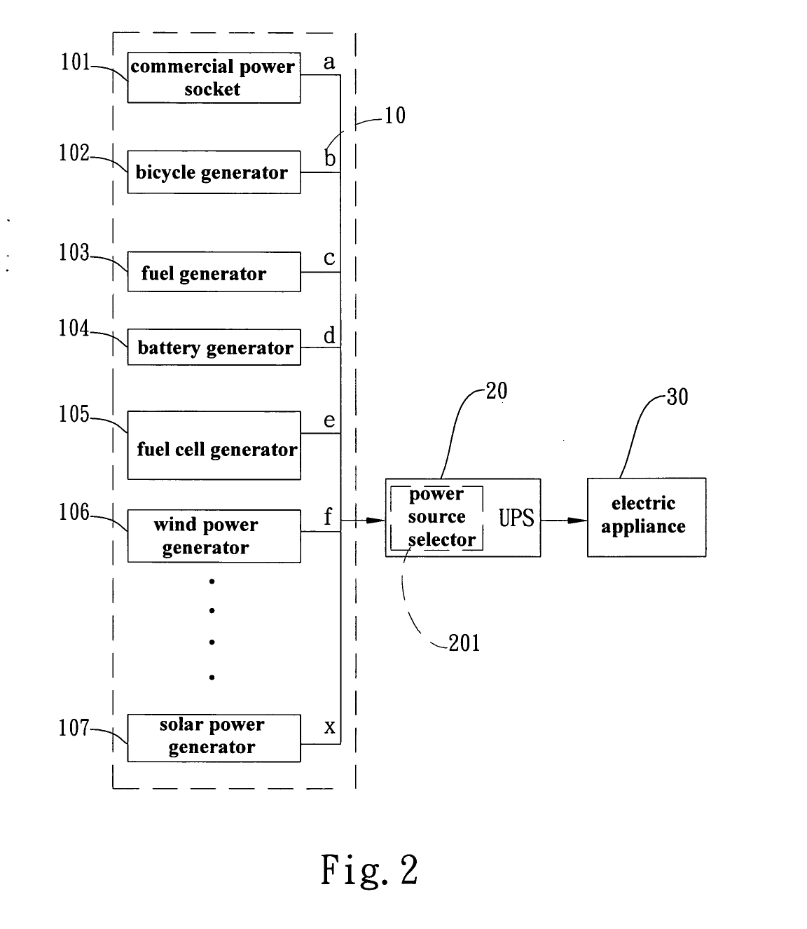

The above-mentioned UPS system 20 has an output terminal for insertion thereinto of an electric appliance 30 such as a computer. Referring to FIG. 2, if the commercial power service is normally obtainable via a commercial power socket 101, the built-in power source selector 201 of the UPS system 20 selects the route a so as to supply the commercial power via the commercial power socket 101 such that the UPS system 20 is also capable of storing the commercial power at the same moment of supplying the commercial power for the electric appliance 30. The UPS system 20 can output the stored commercial power during the commercial power interruption so as to enable the electric appliance 30 to work normally. If the stored commercial power is nearly exhausted and the commercial power service is still unavailable after a period of time, the built-in power source selector 201 of the UPS system 20 makes a selection from the routes b to x except the route a so as to supply the electric power via other power source. The at least three power sources 10 comprise the commercial power service obtained via the commercial power socket 101 and anyone selected from the bicycle generator 102, the fuel generator 103, the battery generator 104, the fuel cell generator 105, the wind power generator 106, the solar power generator 107, and other generator. As a result, if the commercial power service is unavailable, the battery and the fuel may be utilized to enable the battery generator 104 and the fuel generator 103 to supply the electric power for the UPS system 20 and the electric appliance 30. In addition, the manpower bicycle generator may be utilized, wherein the built-in power source selector 201 of the UPS system 20 selects the route b so as to enable the user to obtain the electric power by riding the bicycle generator. Accordingly, the usage duration of the electric appliance 30 can be extended until the commercial power service is restored.

Moreover, if the user resides at a place with powerful natural forces such as wind power or sunlight, the UPS system 20 can output the stored commercial power during the interruption of the commercial power service so as to enable the electric appliance 30 to work normally. If the stored commercial power is nearly exhausted and the commercial power service is still unavailable after a period of time, the built-in power source selector 201 of the UPS system 20 makes a selection from the routes f to x except the route a so as to supply the electric power via the wind power generator 106 or the solar power generator 107. Accordingly, the usage duration of the electric appliance 30 can be extended.

In accordance with the foregoing description, the present invention has the following advantages:

1. The UPS system uses the built-in power source selector to select the proper power source from the at least three power sources. As a result, if the commercial power service is interrupted and the stored commercial power is nearly exhausted, the electric appliance, which is inserted into the UPS system, is still workable.

2. The UPS system uses the built-in power source selector to select the power source other than the commercial power service such that the interruption of the commercial power service does not affect the working of the electric appliance.

In summary, the power storage device of the present invention indeed achieves the anticipated object. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A power storage device, comprising:
at least three power sources, wherein a first power source of said at least three power sources is obtained via a commercial power socket; and
an uninterruptible power supply (UPS) system having a built-in power source selector, wherein said UPS system has an output terminal for coupling with an electric appliance and an input terminal for connection with said at least three power sources via said power source selector, whereby said UPS system can supply the commercial power stored therein for said electric appliance and utilize said built-in power source selector to select a second power source from said at least three power sources during the commercial power interruption so as to enable said electric appliance to work normally.

2. A power storage device of claim 1, wherein said at least three power sources comprise alternating current (AC) and direct current (DC) power sources.

3. A power storage device of claim 1, wherein said second power source of said at least three power sources is a fuel generator, a solar power generator, a wind power generator, a manpower generator, a battery generator, or a fuel cell generator.

4. A power storage device of claim 1, wherein said third power source of said at least three power sources is a fuel generator, a solar power generator, a wind power generator, a manpower generator, a battery generator, or a fuel cell generator.

5. A power storage device of claim 1, wherein said built-in power source selector of said UPS system is a software program.

6. A power storage device of claim 1, wherein said built-in power source selector of said UPS system is a hardware device, and said hardware device is a relay, a reed switch, or a motor.
